(19) United States
(12) Patent Application Publication
(10) Pub. No.: US 2017/0023231 A1
(43) Pub. Date: Jan. 26, 2017

(54) CARRYING BAG WITH REPOSITIONABLE LIGHT

(71) Applicant: Joseph Gonzalez, Waldwick, NJ (US)

(72) Inventor: Joseph Gonzalez, Waldwick, NJ (US)

(21) Appl. No.: 15/160,929

(22) Filed: May 20, 2016

Related U.S. Application Data
(60) Provisional application No. 62/192,926, filed on Jul. 15, 2015.
(60) Provisional application No. 62/164,339, filed on May 20, 2015.

(51) Int. Cl. F21V 33/00; A45C 13/00; F21V 9/16; F21V 23/04; F21V 21/08; F21L 4/00

(52) U.S. Cl. CPC F21V 33/0004; F21V 21/0832; F21L 4/00; F21V 9/16; F21V 23/0414; A45C 13/001; F21Y 2115/10

(57) ABSTRACT

The present disclosure provides a lighting system for a carrying bag having an interior surface that includes a repositionable fastening element having a first surface and a second surface. The first surface of the repositionable fastening element removably adheres to the interior surface of the carrying bag, and the second surface includes at least one fastening feature.

### RELATED APPLICATIONS

This patent application claims the benefit of U.S. Provisional Patent Application Ser. No. 62/192,926, filed Jul. 15, 2015 and U.S. Provisional Patent Application Ser. No. 62/164,339, filed May 20, 2015. This patent application is related to U.S. patent application Ser. No. 13/350,139, filed Jan. 13, 2012. Each of the aforementioned patent applications is incorporated by reference herein in its entirety for any purpose whatsoever.

### INTRODUCTION

There are many instances in daily life where it may be helpful to have a lighting device or element to illuminate a particular space due to low visibility. However, finding an appropriate device for illumination in each instance can prove difficult. For example, when opening a carrying bag or purse in dark or otherwise low visibility environment, it may be difficult to find items inside of the bag. But equipping a bag with a conventional electric light, for example, may be cumbersome and inefficient way to solve this difficulty. The electric light would require a local power source, take up space in the carrying bag, and might not illuminate the space as desired.

It would be helpful to provide a lighting device that can be arranged as desired to illuminate a confined space such as the interior of a carrying bag.

### SUMMARY

The present disclosure provides a lighting system for a carrying bag having an interior surface that includes a repositionable fastening element having a first surface and a second surface. The first surface of the repositionable fastening element removably adheres to the interior surface of the carrying bag, and the second surface includes at least one fastening feature. A lighting device includes a first surface having mating elements for coupling to the at least one fastening feature on the second surface of the repositionable fastening element, and a second surface including a lighting element. In some embodiments, the lighting element may include light emitting diodes (LEDs). Alternatively, the lighting element may include electroluminescent phosphors.

According to some embodiments, the at least one fastening feature on the second surface of the repositionable fastening element includes Velcro® hook and loop elements. The first surface of the repositionable fastening element may include a pressure-sensitive adhesive.

The apparatus and methods of the present invention provide improved illumination in confined spaces such as the interior of a carrying bag.

### BRIEF DESCRIPTION OF THE FIGURES

FIGS. 1A-1G are cross-sections along the width of an exemplary carrying bag showing embodiments for arranging repositionable elements for fastening lighting devices according to the present invention;

FIG. 2A is a frontal view of an exemplary lighting device that may be used with the repositionable elements according to embodiments of the present invention;

FIG. 2B is a rear view of an exemplary lighting device that may be used with the repositionable elements according to embodiments of the present invention;

FIG. 3 is a photograph of an example lighting element, shown emitting, that may be used in a lighting device according to an embodiment of the present invention; and

FIGS. 4A-4D are cross-sections along the width of an exemplary carrying bag showing lighting devices coupled to repositionable fastening elements within the bag according to exemplary embodiments of the present invention.

### DETAILED DESCRIPTION

Descriptions herein of the apparatus and methods of the present disclosure as depicted in the Figures represent conceptual embodiments of systems embodying the principles of the disclosed embodiments. It should be understood that these figures and embodiments are exemplary in nature and in no way serve to limit the scope of the disclosure.

The present invention provides a system for lighting a carrying bag that includes at least one repositionable fastening element that, on a first side, removably adheres to interior surfaces of the bag, and on a second side, provides a surface for fastening a lighting device. The lighting device in turn is equipped with features for coupling to the fastening element on one side, and on the opposite side includes a lighting element that is particularly suited to provide illumination to interior areas of a carrying bag. As the fastening elements, and the lighting devices that are attached to them, are repositionable, areas of different sizes and positions in the interior of the carrying bag can be illuminated. For example, specific areas of the inside of the bag that tend to be more occluded than others can be provided with more light.

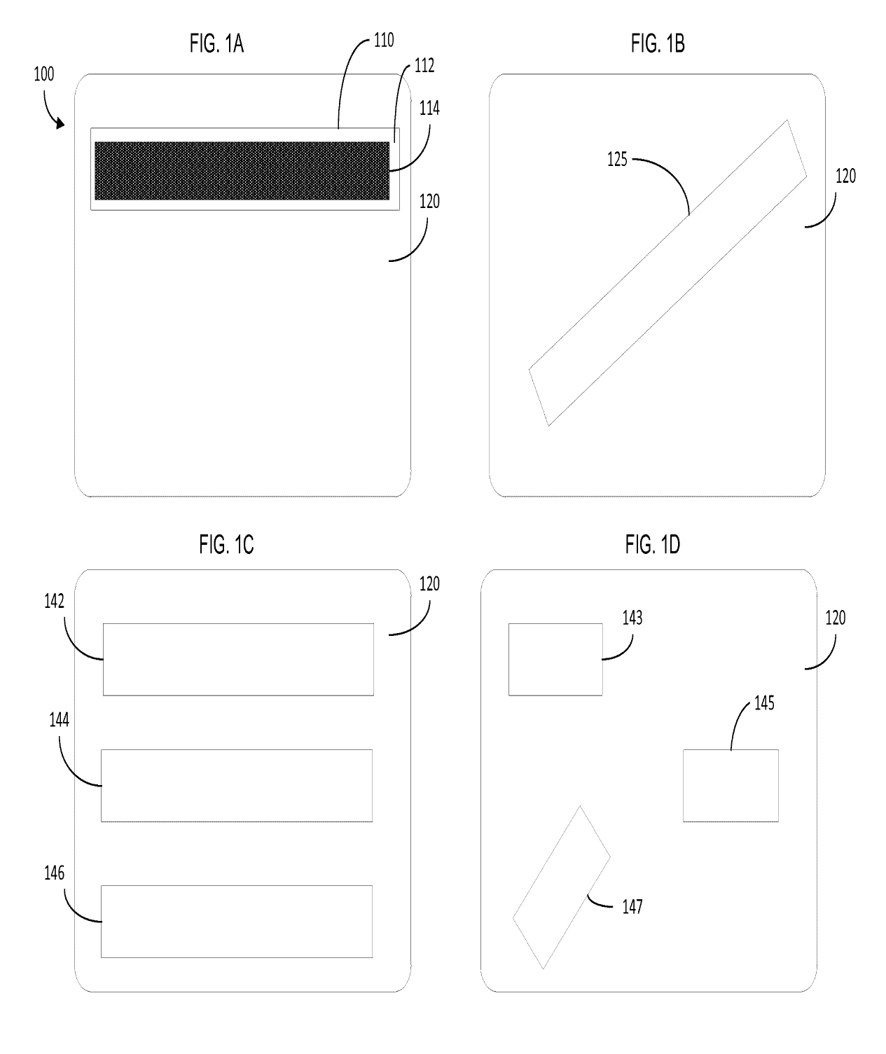

FIGS. 1A through 1G are various cross-sections along the width of an exemplary carrying bag 100 showing embodiments for arranging repositionable elements for fastening lighting devices according to the present invention. The rounded-square shape of the cross-section in FIGS. 1A through 1G should be taken as merely exemplary and the inventive teachings described herein can be applied to any carrying bag, briefcase, knapsack, purse, and in general, any container having spaces that are darkened, occluded or otherwise lack visibility.

In FIG. 1A, a repositionable fastening element 100 is shown coupled in a horizontal orientation on the interior surface 120 of the carrying bag. In the embodiment of FIG. 1A, the repositionable element is a rectangular, elongate member having a first surface (not shown) which removably adheres to the interior surface 120 of the bag, by for example, using a pressure-sensitive tape as known in the art. A second surface 112 of the repositionable fastening element 110 includes fastening features, e.g., 114, such as hook and loop elements (e.g., Velcro®), buttons, snaps tabs and the like. In a preferred embodiment, the repositionable element may comprise a Velcro Brand® Sticky Back® fastener. As the exposed surface 112 of the fastening element no includes fastening features 114, it may serve as a platform to which lighting elements having corresponding mating elements may be fastened. FIG. 1B shows another embodiment in which a repositionable fastening element 125, similar to element 110 shown in FIG. 1A is repositioned on the interior surface 120 of the carrying back in a diagonal orientation.

FIG. 1C shows another exemplary embodiment in which instead of a single repositionable fastening element, a plurality of repositionable fastening elements 142, 144, 146 are coupled to the interior 120 of the bag. FIG. 1D shows another embodiment in which the widths of repositionable fastening members 143, 145, 147 are reduced in comparison to the embodiments shown in FIGS. 1A-1C. The embodiment of FIG. 1D may be used to fasten smaller lighting devices to illuminate smaller, more specific regions of the interior of the bag.

In FIG. 1E, repositionable fastening element 150 has a more complex shape, including a horizontally aligned portion and two vertically arranged portions. In this arrangement, when a lighting device is attached to the fastening element 150, a larger region of the interior of the carrying bag may be illuminated.

FIG. 1F shows a plurality of circular-shaped repositionable fastening elements 162, 164, 166 coupled to the interior 120 and FIG. 1G shows a single, larger ellipse-shaped repositionable fastening element 170 similarly coupled to the interior 120 of the carrying bag.

The embodiments depicted in FIGS. 1A to 1G together are meant to illustrate that repositionable fastening elements for lighting elements according to the present invention can be placed on the interior surface of a carrying bag in a wide variety of numbers, shapes, sizes, spatial arrangements and orientations, and should not be viewed or interpreted in a limiting sense. Additionally, while only FIG. 1A depicts fastening features explicitly, it is to be understood that all of the repositionable fastening elements shown in FIGS. 1B-1G also include fastening features.

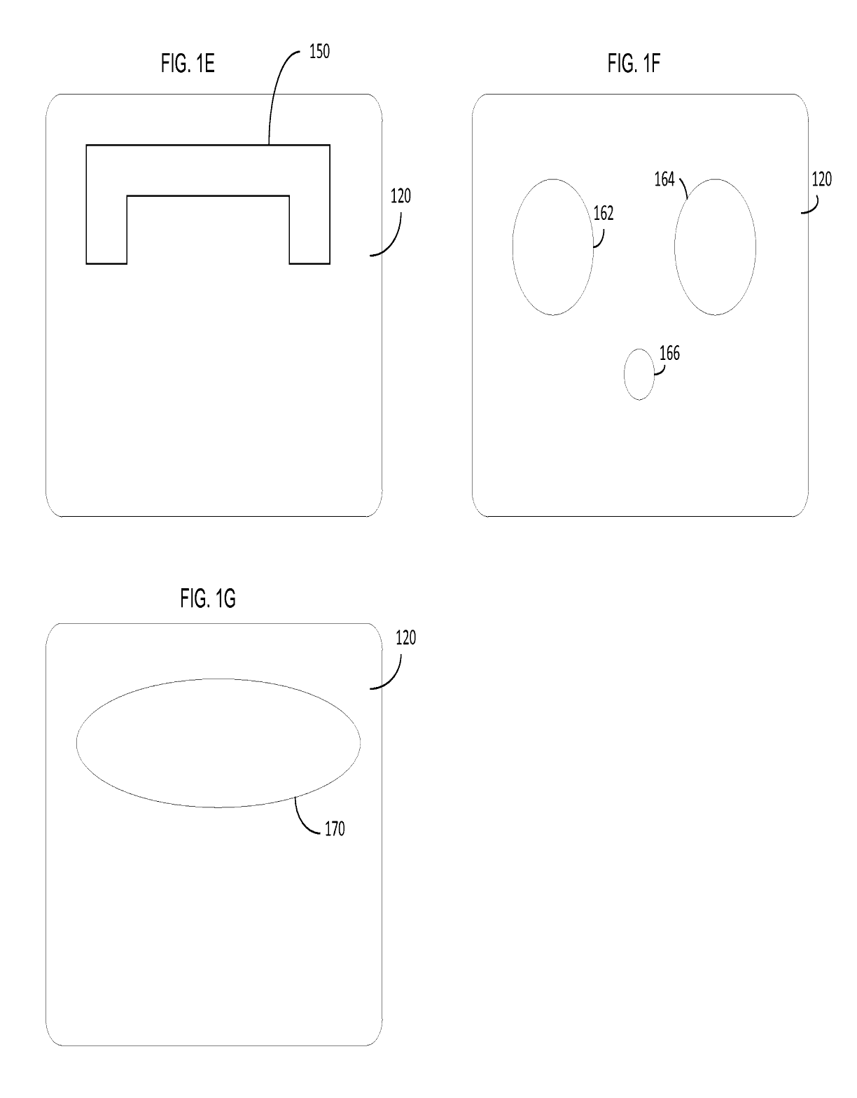

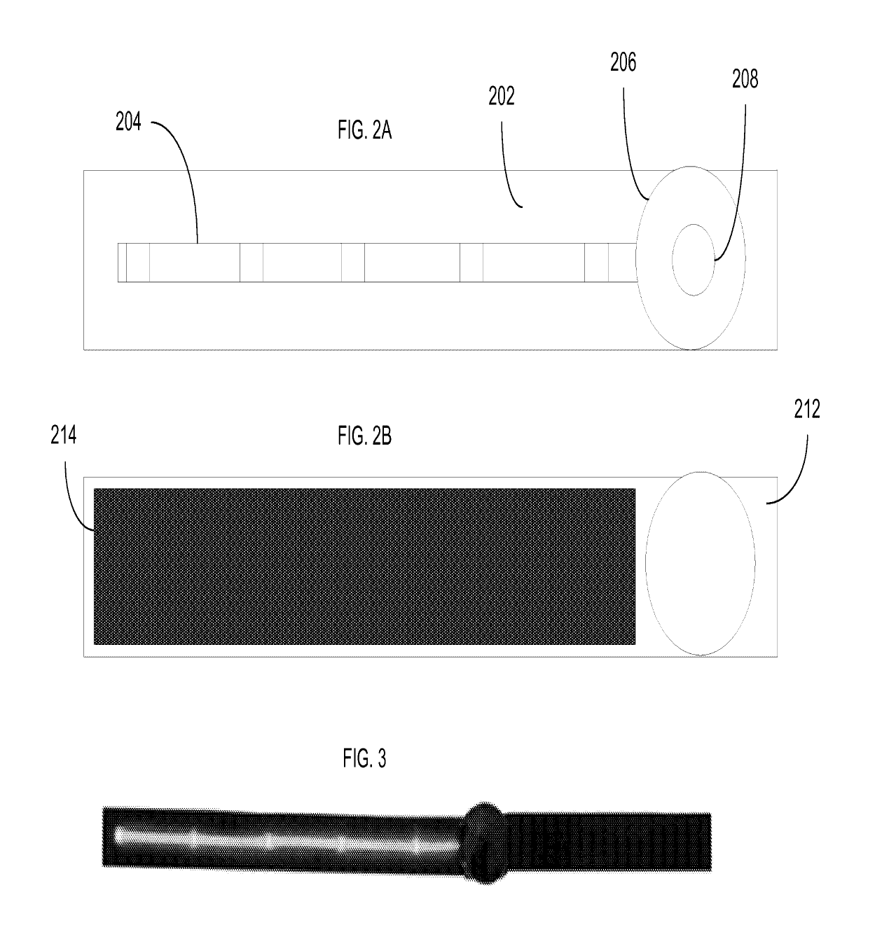

FIG. 2A illustrates a frontal view of an exemplary lighting device 200 according to an embodiment of the present invention. The front surface 202 of the lighting device 200 includes a backing fabric 202, which may be composed of an elastic material, an elongate lighting element 204, and battery housing 206 which includes a switch 208. The elongate lighting element 204 may be implemented in different ways including using electroluminescent phosphors and LEDs. In an implementation in which electroluminescent phosphors are used, lighting element 204 may include a plurality of light-emitting segments disposed along the longitudinal axis connected to each other by narrower segments. An example photograph of a lighting element of this type which may be used in the context of the present invention is shown in FIG. 3 (depicted while emitting). In other embodiments, the electroluminescent element may be a continuous, monolithic element. The lighting element 204 may emit different colors depending on the voltage supplied. Further details of electroluminescent phosphor elements that may be used in the context of the present invention may be found in above-referenced U.S. patent application Ser. No. 13/350,139. When LEDs are used, the lighting element 204 may comprise a strip of connected LEDs.

The active portions of the lighting element 204 may be enclosed within a luminary, or tubular encasement which may include a layer of fluorescent or reflective photoluminescent material to enhance intensity or color effects. The tubular member is preferably transparent or translucent and defines areas of brightness proximate the active portions of the lighting element 204, and dimmer areas in between. This “dashed” design requires energizing a smaller amount of surface area than a similar strip which is energized uniformly. As a result, for a given amount of power, the intensity of the light transmitted is higher and appears brighter; or conversely, for a given intensity of transmitted light, the power consumed is lower. The spectral distribution of the emitted light is selected to achieve optimal visibility under device power constraints, and may be in the 480 nm to 520 nm range, with intensities in a range of 300-700 Lumens, as an example.

Although the lighting element 204 is depicted in a straight line form in FIG. 2A, this is not necessary, and the various active portions and connectors of the lighting element can be arranged variously such as in curved lines, circles, ellipses, etc.

The battery housing 206 includes one or more batteries (not shown) for providing electrical power to the lighting element 204 and a switch 208 which may be used to connect/disconnect the one or more batteries from the lighting element 204. In some embodiments, the one or more batteries may provide a voltage in a range of 1.5 to 3.0V, although other voltages may be used. The battery housing 206 may also include one or more electrical circuits (not shown), such as timers and inverters, to modify the power signal provided to the lighting element 204 so as to cause the lighting element to flash in a repeating pattern or a set number of flashes; alternatively, the lighting element 204 may emit continuously while the switch is in an ‘on’ position. Circuitry in the battery housing 206 may also be used to automatically shut off electrical power from the lighting element after a certain time to conserve battery power.

FIG. 2B illustrates a rear view of the exemplary lighting device 200 according to an embodiment of the present invention. As shown, the rear surface 212 of the lighting device includes a mating surface 214 which may encompass the entirety of rear surface 212 or a portion thereof, which includes elements configured to mate with corresponding fastening features of a repositionable fastening element such that the rear surface can be attached and fastened to the exposed front surface of a repositionable fastening element. Accordingly, the mating surface 214 may include hook and loop elements (e.g., Velcro®), buttons, snaps tabs and the like.

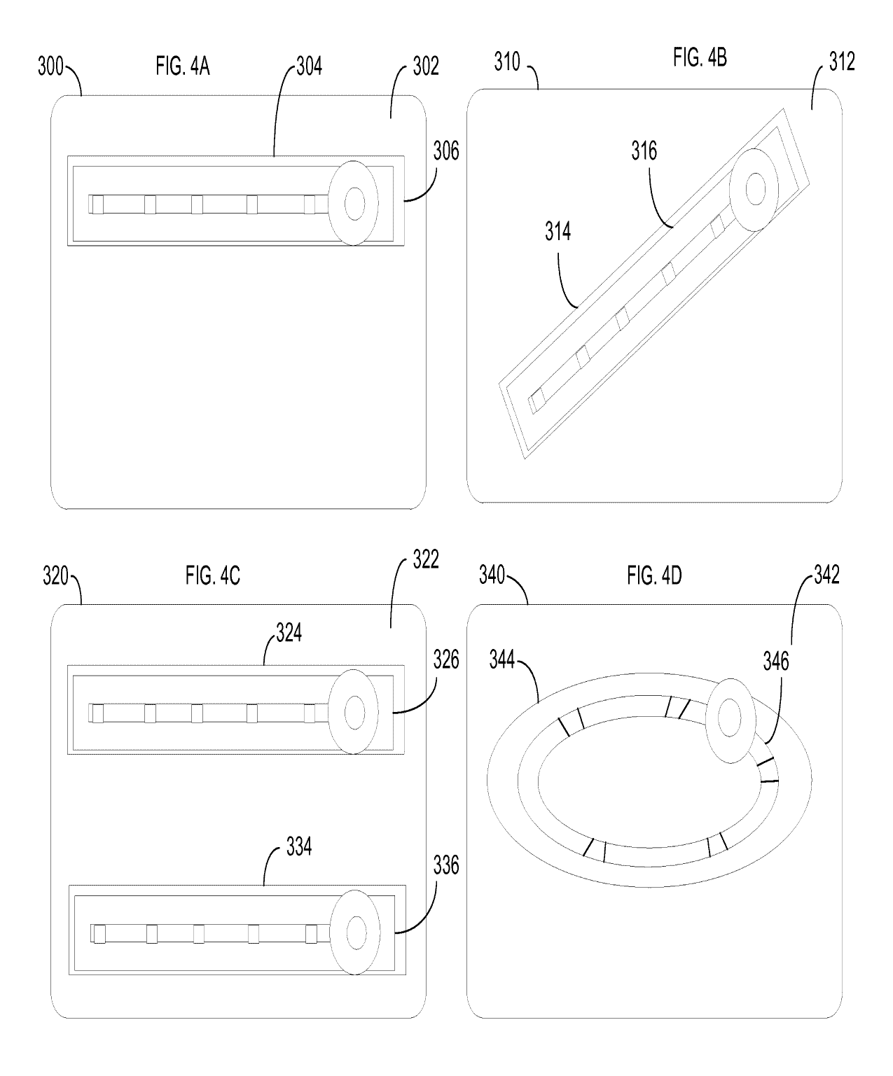

FIG. 4A-4D illustrate lighting systems for a carrying bag according to different embodiments of the present invention. FIG. 4A shows an interior surface 302 of a carrying bag 300 on which a rectangular-shaped fastening element 304 is attached and positioned in a horizontal orientation on a upper portion of the interior surface 302. The fastening element 304 in turn secures a lighting device 306 having similar dimensions to the fastening element. The lighting device 306 may include fastening features as discussed above which mate with corresponding fastening features of the fastening element 304. The fastening element 304 may be secured to the interior surface 302 using a pressure-sensitive adhesive as mentioned above.

FIG. 4B shows an alternative embodiment in which a rectangular-shaped fastening element 314 is attached and positioned diagonally from the lower left to the upper right of the interior surface 312 of a carrying bag 310. A lighting device 316 secured to the fastening element 314 is correspondingly oriented diagonally and may illuminate different sections of the interior of the bag 310 (or similar sections with different intensities) in comparison to the lighting system shown in FIG. 4A.

FIG. 4C shows an alternative embodiment in which the interior surface 322 of a carrying bag 320 is equipped with two fastening elements 324, 334 and two corresponding lighting devices 326, 336, with the first fastening element 324/lighting device 326 unit positioned horizontally across an upper portion of the interior surface 322 and the second fastening element 334/lighting device 336 unit positioned horizontally across a lower portion of the interior surface 322. FIG. 4C is intended to illustrate that a plurality of lighting elements may be employed to illuminate a bag; however, the orientation, size and shape shown in FIG. 4C are exemplary and not to be taken as limiting.

FIG. 4D shows an alternative embodiment in which the interior surface 342 of a carrying bag 340 is equipped with an elliptically-shaped fastening element 344 positioned centrally on the interior surface 342 of a carrying bag 340. The corresponding lighting device 346 secured to the fastening element 344 is an elongate member curved into an elliptical shape. In this configuration, the illumination of the may have different characteristics in comparison to other embodiments, which may advantageous for particular purposes.

Although the present disclosure herein has been described with reference to particular preferred embodiments thereof, it is to be understood that these embodiments are merely illustrative of the principles and applications of the disclosure. Therefore, modifications may be made to these embodiments and other arrangements may be devised without departing from the spirit and scope of the disclosure.

What is claimed is:

1. A lighting system for a carrying bag having an interior surface, comprising:
a repositionable fastening element having a first surface and a second surface, the first surface removably adhering to the interior surface of the carrying bag, the second surface including at least one fastening feature; and
a lighting device including a first surface including mating elements for coupling to the at least one fastening feature of the second surface of the repositionable fastening element, and a second surface including a lighting element.

2. The lighting system of claim 1, wherein the lighting element includes light emitting diodes (LEDs).

3. The lighting system of claim 1, wherein the light element includes electroluminescent phosphors.

4. The lighting system of claim 1, wherein the at least one fastening feature on the second surface of the repositionable fastening element includes Velcro.

5. The lighting system of claim 1, wherein the first surface of the repositionable fastening element includes a pressure-sensitive adhesive.

6. The lighting system of claim 1, wherein the lighting device includes at least one battery.
